(19) United States
(12) Patent Application Publication
(10) Pub. No.: US 2002/0130010 A1
(43) Pub. Date: Sep. 19, 2002

(54) Friction clutch plate

(76) Inventors: David Landa, Pensacola, FL (US); Raymond Engel, Pensacola, FL (US)

Correspondence Address: STEPHEN E. FELDMAN, P.C., 12 East 41st Street, New York, NY, 10017, US

(21) Appl. No.: 09/809,937

(22) Filed: Mar. 19, 2001

(51) Int. Cl. F16D 69/02

(52) U.S. Cl. 192/107 M; 428/292.7

(57) ABSTRACT

The present invention is directed to a paper based clutch plate that can be used in a transmission of a land motor vehicle. The clutch plate has a top paper layer and a bottom paper layer. The top paper layer is attached through an adhesive tie layer to the a top base paper layer, which in turn is attached through another adhesive tie layer to a steel core layer. The bottom paper layer is attached to a bottom base paper layer using another adhesive tie layer. The bottom base paper layer is attached to a steel core layer using an adhesive tie layer. All of the adhesive tie layers are fabricated using conventionally known adhesives.

### FIELD OF INVENTION

The present invention relates to the field of land motor vehicle transmission systems. More specifically, the present invention relates to a clutch system in automatic transmission or transaxle systems. In particular, the present invention relates to a friction clutch plates of a clutch system of a land motor vehicle's transmission. The present invention presents a cost effective system to manufacture friction clutch plates of a land motor vehicle due to specific type components that are used in producing such plates.

### BACKGROUND OF THE INVENTION

There are several apparatuses that are conventionally well known for clutch plates of a clutch system of land motor vehicle transmission. However, there are several problems that are associated with present known technology. The present structure of the clutch plates does not provide the many characteristics, such as strength and durability, as the present invention provides. The present invention further addresses the long felt but unfulfilled need.

There are several U.S. patents that are available in the field of friction clutch plates, however, none of them address the long felt need that the present invention does.

U.S. Pat. No. 2,218,535 to Judd teaches an apparatus and method for making a friction facing. This patent discloses a clutch facing having alternate thin layers of foraminated heat resisting felted asbestos base sheet material and a compound of hardened rubber cement binder comprising fillers, the layers being perpendicular to the wearing face of the clutch facing. Furthermore, an invention comprises a friction element suitable for a clutch facing comprising an annular body formed of thin layers of perforated asbestos base paper coated with a hardened binder capable of being hardened and rendered infusible comprising filter. The present invention comprises a multi-layered paper based clutch comprising of a top and a bottom paper layers a steel core layer and paper base layers attached to the top and bottom paper layers using the adhesive tie layers.

U.S. Pat. No. 3,927,241 to Augustin teaches a friction element for friction engaging mechanisms. The element contains an intermediate layer arranged between core member and the friction facing. The intermediate layer comprises of a felt or web of a paper like structure, which is made basically of fibers other than carbon fibers, such as cellulosic fibers or synthetic fibers or asbestos fibers. The present invention comprises of a multi-layered paper clutch plate, having a steel core, several base paper layers and top and a bottom paper layers. All of the layers are attached by adhesive tie layers.

The prior art in question presents numerous problems that the present invention addresses and resolves. These problems are low speed sorting of containers and damaging of such containers when they are on the conveyor. The present invention addresses a long felt but unfulfilled need for a better container unscrambling apparatus and method.

### SUMMARY OF THE INVENTION

The present invention is directed towards friction clutch plates.

Another object of the present invention is to create a paper based friction clutch plates for use in a transmission of a land motor vehicle.

Other objects of the present invention will become apparent from the following description.

### BRIEF DESCRIPTION OF THE DRAWINGS

The following description of preferred embodiment of the present invention will be better understood when read in conjunction with the appended drawings. It should be understood, however, that the invention is not limited to the precise arrangements shown in which:

FIG. 1 is a perspective view of a paper based friction clutch plate.

### DESCRIPTION OF THE PREFERRED EMBODIMENT

The present invention relates to a field of clutch plates, more specifically to the field of paper based friction clutch plates. The present invention would be better understood in conjunction with a following description of a preferred embodiment. However, it is understood by one skilled in the art that the present invention is not limited to the above referenced specific embodiment, but other embodiments are allowable, provided they are within the scope and spirit of the following claims.

In the following description, references to the drawings, certain terms are used for conciseness, clarity and comprehension. It is assumed by one skilled in the art that there are to be no unnecessary limitations implied from the such references, besides the limitations imposed by the prior art, because such terms and references are used for descriptive purposes only and intended to be broadly construed. Furthermore, the description and the drawings are for illustrative purposes only and not to be construed as limited to the exact details shown, depicted, represented, or described.

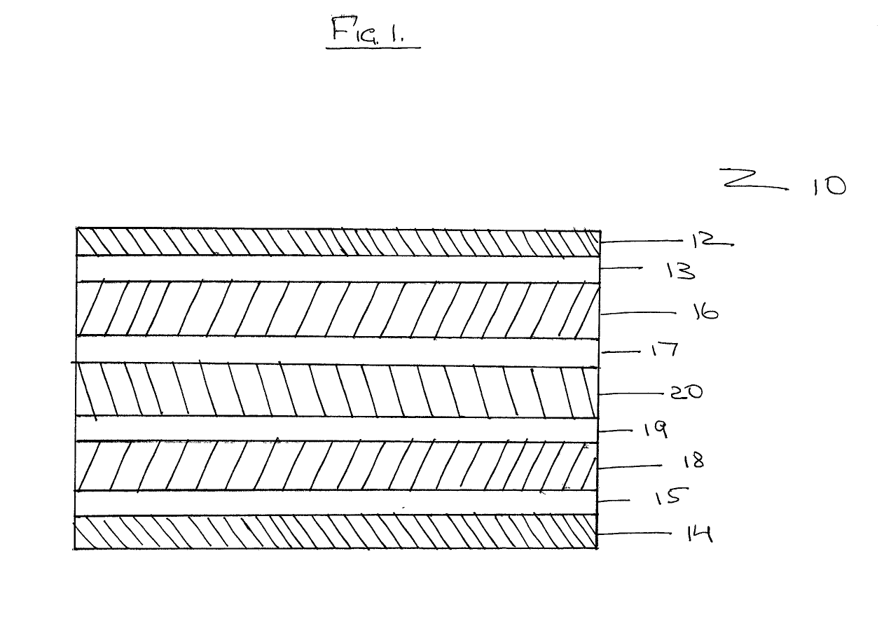

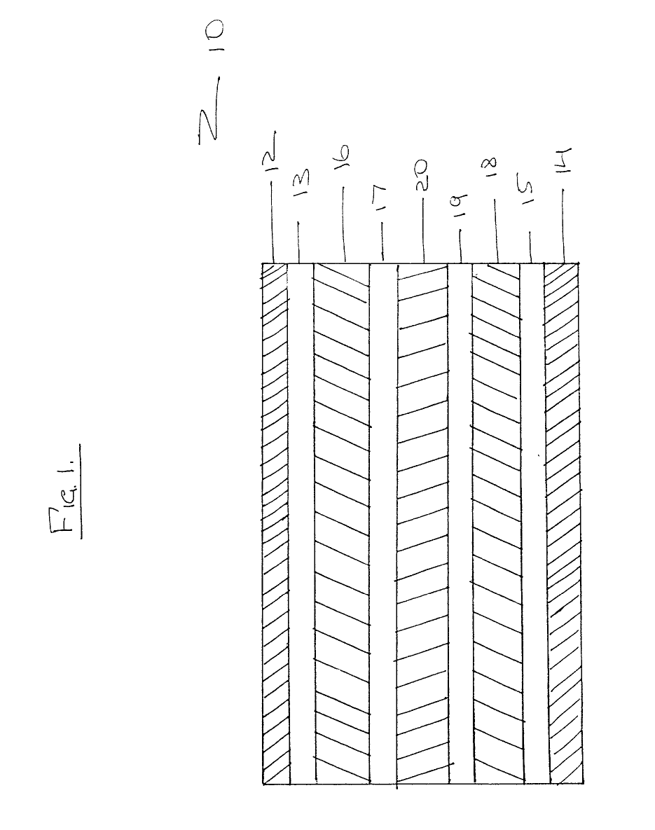

Referring to FIG. 1, the present invention is shown to be a multi-layered paper based clutch plate 10. The clutch plate 10 is shown to have a top face friction layer 12 and a bottom face friction layer 14. Both the top face friction layer 12 and the bottom face friction layer 14 are paper-based layers and serve as top and bottom friction layers, respectively. When fabricating the friction layers 12 and 14, it is assumed by one skilled in the art that a paper having a suitable weight and thickness will be used.

Referring to FIG. 1, the clutch plate 10 is shown to have a steel core layer 20. The steel core layer 20 may be fabricated from any conventionally known qualities of steel that are suitable for the purposes of the present invention. The steel core layer 20 serves as a center layer that holds the clutch plate 10 together. The steel core layer 20 has top base paper layer 16 and a bottom base paper layer 18 attached to it through adhesive tie layers 17 and 19, respectively, as shown in FIG. 1.

The top and bottom base paper layers are attached to the top and bottom friction layers 12 and 14 using a adhesive tie layer 13 and 15, respectively. The adhesive tie layers, 13, 15, 17, and 19 are comprise of adhesive material capable of permanently attaching different materials together and after such attachment capable of holding such materials together on a permanent basis. The adhesive tie layers may be fabricated using glue, epoxy or any other conventionally known adhesives materials.

In one embodiment, it is preferred that the top face friction layer 12 and a bottom face friction layer 14 are manufactured from a more dense material than top base paper layer 16 and a bottom base paper layer 18. It is possible to fabricate the top and the bottom face friction layers (12 and 14 respectively), from a 100% knitted Kevlar paper. The Kevlar based paper has a characteristic of resisting high temperatures and that is why it is an excellent material for the purposes of the friction clutch plate. Furthermore, the use of the Kevlar based paper is more effective when the friction clutch plates are being manufactured. In another embodiment, it is possible to manufacture these layers from carbon fiber based paper. However, a drawback to such process is the cost of using such plates. Carbon fiber based paper is very expensive and would not suit the needs and goals of the present invention as well as the knitted Kevlar paper would.

In another embodiment, the top and the bottom base layers 16 and 18, respectively, may also be fabricated from a knitted Kevlar paper, due to the fact that high heat resistance qualities of this material. Furthermore, the top and the bottom face layers 14 and 16 are approximately three times thinner than the top and the bottom base paper layers 16 and 18. However, other embodiments are possible and thickness of each layer may be varied proportionally to each other. Therefore, depending on a material used in manufacturing the plates it is possible that the thickness of the paper base layers may be reduced with respect to the thickness of the face layers.

Yet, in another embodiment, the top and the bottom face layers have a higher Kevlar content coefficient rather than the paper base layers. This is because the face layers are more readily subjected to friction and therefore heat, when used while the land motor vehicle is in operating condition, rather than the base paper layers which experience less friction and, therefore, serve as heat absorbers, thus, requiring lesser coefficient of the Kevlar in them.

Furthermore, in another embodiment, the adhesive tie layers may be fabricated from a phenolic adhesive glue. Such glue may be designed so that it withstands high temperatures and pressure that is being put on the friction clutch plate. Yet in another embodiment, the clutch plate adhesive layers may be manufactured from other epoxies, such as polyvinyl and rubber-butyl based epoxies. However, it must be understood by one skilled in the art that other adhesive materials may be used for such purpose.

In the foregoing description of the invention, reference to the drawings, certain terms, have been used for clarity, conciseness and comprehension. However, no unnecessary limitations are to be implied from or because of the terms used, beyond the requirements of the prior art, because such terms are used for descriptive purposes and are intended to be broadly construed. Furthermore, the description and illustration of the invention are by way of example, and the scope of the invention is not limited to the exact details shown, represented, or described.

While the present invention has been described with reference to specific embodiments, it is understood that the invention is not limited but rather includes any and all changes and modifications thereto which would be apparent to those skilled in the art and which come within the spirit and scope of the appended claims.

What is claimed:

1. A friction clutch plate means comprising
a top face;
a top base layer, wherein said top base layer is attached to said top face with a first intermediate means;
a core layer, wherein said core layer is attached to said top base layer with a second intermediate means;
a bottom base layer, wherein said bottom base layer is attached to said core layer with a third intermediate means;
a bottom face, wherein said bottom face is attached to said bottom base layer with a fourth intermediate means.

2. A friction clutch plate means of claim 1, wherein said top face further comprises a top face paper layer.

3. A friction clutch plate means of claim 2, wherein said top face paper layer comprises a knitted Kevlar paper

4. A friction clutch plate means of claim 2, wherein said top face paper layer comprises a carbon fiber based paper.

5. A friction clutch plate means of claim 1, wherein said bottom face further comprises a bottom face paper layer.

6. A friction clutch plate means of claim 5, wherein said bottom face paper layer comprises a carbon fiber based paper.

7. A friction clutch plate means of claim 5, wherein said bottom face paper layer comprises a carbon fiber based paper.

8. A friction clutch plate means of claim 1, wherein said core layer further comprises a steel core layer.

9. A friction clutch plate means of claim 1, wherein said top base layer further comprises a top base paper layer.

10. A friction clutch plate means of claim 9, wherein top base face paper layer comprises a carbon fiber based paper.

11. A friction clutch plate means of claim 9, wherein said top base paper layer comprises a carbon fiber based paper.

12. A friction clutch plate means of claim 1, wherein said bottom base layer further comprises a bottom base paper layer.

13. A friction clutch plate means of claim 12, wherein said bottom base paper layer comprises a carbon fiber based paper.

14. A friction clutch plate means of claim 12, wherein said bottom base paper layer comprises a carbon fiber based paper.

15. A friction clutch plate means of claim 1, wherein said top base paper layer is thicker than top face layer and said bottom base paper layer is thicker than bottom face layer.

16. A friction clutch plate means of claim 1, wherein said first intermediate means further comprises of an adhesive, glue or other conventionally known adhesive material.

17. A friction clutch plate means of claim 1, wherein said second intermediate means further comprises of an adhesive, glue or other conventionally known adhesive material.

18. A friction clutch plate means of claim 1, wherein said third intermediate means further comprises of an adhesive, glue or other conventionally known adhesive material.

19. A friction clutch plate means of claim 1, wherein said fourth intermediate means further comprises of an adhesive, glue or other conventionally known adhesive material.
